(19) United States
(12) Patent Application Publication
(10) Pub. No.: US 2024/0413529 A1
(43) Pub. Date: Dec. 12, 2024

(54) FOURTH ORDER ORBITAL ANGULAR MOMENTUM (OAM) MODE PATCH ANTENNA

(71) Applicant: KING FAHD UNIVERSITY OF PETROLEUM AND MINERALS, Dhahran (SA)

(72) Inventors: Rifaqat HUSSAIN, Dhahran (SA); Umar FAYYAZ, Dhahran (SA); Shahab Ahmad NIAZI, Dhahran (SA); Abdul AZIZ, Dhahran (SA); Abdullah AL-GARNI, Dhahran (SA)

(73) Assignee: KING FAHD UNIVERSITY OF PETROLEUM AND MINERALS, Dhahran (SA)

(21) Appl. No.: 18/330,400

(22) Filed: Jun. 7, 2023

(51) Int. Cl. H01Q 3/26; B41M 5/00; H01Q 9/04

(52) U.S. Cl. CPC H01Q 3/26; B41M 5/0047; H01Q 9/0464

(57) ABSTRACT

A fourth order orbital angular momentum (OAM) four patch antenna is described. The antenna includes a dielectric substrate, a metallic sheet, and a four patch antenna. The four patch antenna includes a circular ring path patch, a first feed branch patch, and a second feed branch patch. The first feed branch patch is connected to the circular ring path patch. The second feed branch patch includes a straight leg which extends radially from the circular ring path patch and a curved leg having a first end connected to the straight leg and a second leg connected to the first end of feed port patch. The antenna is configured to resonate in a fourth order OAM mode at a frequency of 5.12 GHz when an electrical input signal is applied to a second end of the feed port patch.

### BACKGROUND

### Technical Field

The present disclosure is directed to a fourth order orbital angular momentum (OAM) mode patch antenna.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The demand for higher data rates and secure communications is constantly increasing with mobile electronic gadgets, emerging multimedia applications such as voice over IP, video conferencing, online gaming, high-definition video streaming, the emerging use of the Internet of Things (IoT) in various monitoring systems, and machine-to-machine data sharing applications. Wireless communication systems face serious challenges in improving data transmission as the allowed spectrum and signal polarization are limited. Employing free space electromagnetic (EM) waves, microwave (MW), or radio frequency (RF) waves is becoming common in various communications and data transmission applications.

The electromagnetic wave includes linear momentum and angular momentum. The angular momentum has a spin angular momentum (SAM) and an orbital angular momentum (OAM). The OAM waves do not interact with each other during propagation in a homogeneous medium and form an orthogonal set of propagating modes (known as OAM modes). The OAM modes represent a way to implement channel multiplexing. The OAM modes have orthogonality, thereby simplifying signal processing. The OAM modes implement a multi-channel high-rate data link with low-complexity processing.

Different approaches have been used to generate the OAM waves in antenna systems like spiral reflectors, meta-surfaces, spiral phase plates, antenna arrays, etc. The first three of these approaches successfully change the plane waves into OAM waves through transmission or reflection. However, further development of these approaches is restricted due to their single operating frequency and complex processing. The antenna arrays also require a feeding network for the excitation of antenna elements with equal amplitude and different phase shifts. The OAM modes generated by an antenna depends on the number of antenna elements and the phase shift between them. Consequently, the complexity of antenna systems for the generation of OAM beams is increased in order to meet such conditions.

Recently, for the purpose of producing an OAM beam, a single patch antenna has been designed to use either a single feed network or a dual feed network. The use of the single feed network is limited as unwanted non-zero OAM modes are generated as from a surface of the patch in addition to the required OAM modes for the OAM antenna. The dual feed network is preferred in implementations as it only generates the required OAM mode and overcomes the issue of generating other non-zero OAM modes.

An existing antenna employs a ring patch to achieve a third-order OAM mode (See: Li, W., Zhu, J., Liu, Y., Zhang, B., Liu, Y., & Liu, Q. H. “Realization of third-order OAM mode using ring patch antenna”, IEEE Transactions on Antennas and Propagation 2020, 68 (11), pp. 7607-7611). However, the purity of the generated OAM mode gets degraded as equal-scale superposition of the two orthogonal modes cannot be well achieved.

Another existing antenna has been described that generates circularly polarized vortex EM waves with different OAMs at 2.4 GHz using a conical conformal patch antenna (CCPA) and a single-feed point (See: Shen, Fei, Jiangnan Mu, Kai Guo, and Zhongyi Guo. “Generating circularly polarized vortex electromagnetic waves by the conical conformal patch antenna” IEEE Transactions on Antennas and Propagation 67, no. 9, 2019, pp. 5763-5771). However, the antenna is limited to operating at 2.4 GHz, limiting its practical implementation. Further, the described antenna requires an additional conical horn outside of the CCPA to enhance the performance of the antenna.

A water antenna has been designed to generate tunable OAM vortex waves. Further, a dual-ring water antenna having two annular grooves and two shorted ring patches has been described. (See: Ming, Jie, and Yan Shi. “A mode reconfigurable orbital angular momentum water antenna”, IEEE Access vol no 8, 2020, pp. 89152-89160). The dual-ring water antenna requires a complex feeding network that includes two Wilkinson dividers combined by a T-junction power divider, and two two PIN diodes.

Generating the first-order vortex electromagnetic waves using an octagonal patch antenna based on the characteristic mode theory (CMT) has been described (See: Wang, Y., Sun, X., Liu, L., Zhao, L., Zhang, Y. and Yuan, Y., “a single-fed octagonal OAM antenna based on CMT”, 7th International Conference on Computer and Communications (ICCC) 2021 December, pp. 2180-2184). However, this reference is limited to providing a first order OAM beam only.

The systems and methods described in these references and other conventional systems suffer from various limitations including utilization of the dual feed network to generate required modes only, however the dual feed network requires complex feed network with appropriate dimensions.

Hence, there is a need for a higher order OAM mode patch antenna which has a compact size, planar geometry and simple feed structure which can generate a fourth order orbital angular momentum (OAM) mode.

### SUMMARY

In an embodiment, a fourth order orbital angular momentum (OAM) four patch antenna is described. The antenna includes a dielectric substrate, a metallic sheet, and a four patch antenna. The dielectric substrate includes a top side and a bottom side. The metallic sheet is configured to cover the bottom side. The metallic sheet is configured to connect to an electrical ground. The four patch antenna is located on the top side. The four patch antenna includes a circular ring path patch, a first feed branch patch, and a second feed branch patch. The first feed branch patch is operatively connected to the circular ring path patch. The first feed branch patch includes a straight leg which extends radially from the circular ring path patch and a curved leg having a first end connected to the straight leg. The curved leg is spaced from the circular ring path patch by a constant distance. A first end of a feed port patch is connected to a second end of the curved leg. The feed port patch extends radially away from the circular ring path patch. The second feed branch patch is connected to the circular ring path patch. The second feed branch patch includes a straight leg which extends radially from the circular ring path patch and a curved leg having a first end connected to the straight leg and a second leg operatively connected to the first end of feed port patch. The curved leg is spaced from the circular ring path patch by a constant distance and wherein a length of the curved leg of the second feed branch is one half a length of the curved leg of the first feed branch patch. The fourth order OAM four patch antenna is configured to resonate in a fourth order OAM mode at a frequency of 5.12 GHz when an electrical input signal is applied to a second end of the feed port patch.

In another exemplary embodiment, a method of making a fourth order orbital angular momentum (OAM) four patch antenna. The method includes selecting a dielectric substrate including a top side and a bottom side, a first edge, a length of about 150 mm and a width of about 150 mm, a top side, a bottom side, a first edge opposite a second edge, and a third edge opposite a fourth edge, a first central axis bisecting the length and extending from the first edge to the second edge, a second central axis bisecting the width and extending from the third edge to the fourth edge. The method includes covering the bottom side with a metallic sheet. The method includes connecting an edge of the metallic sheet to an electrical ground. The method includes forming a four patch antenna on the top side. Forming the four patch antenna includes forming a circular ring path patch having a center located at an intersection of the first central axis and the second central axis, forming a first feed branch patch connected to the circular ring path patch, wherein the first feed branch patch includes a straight leg which extends radially outward from an outer perimeter of the circular ring path patch, and a curved leg having a first end connected to the straight leg, wherein the curved leg is spaced from the circular ring path patch by a constant distance, forming a feed port patch having a first end operatively connected to a second end of the curved leg of the first feed branch patch, wherein the feed port patch extends from the circular ring path patch towards the second edge and is coincident with the first central axis, and forming a second feed branch patch connected to the circular ring path patch, wherein the second feed branch patch includes a straight leg which extends radially outward from the circular ring path patch and a curved leg having a first end connected to the straight leg of the second feed branch patch and a second end operatively connected to the first end of the feed port patch, wherein the curved leg is spaced from the circular ring path patch by a constant distance and wherein a length of the curved leg of the second feed branch is one half a length of the curved leg of the first feed branch. The method includes connecting an electrical input signal to a second end of the feed port patch, wherein the electrical input signal is configured to cause the fourth order OAM four patch antenna to resonate in a fourth order OAM mode at a frequency of 5.12 GHz.

In another exemplary embodiment, a method for transmitting fourth order orbital angular momentum (OAM) signals at a frequency of 5.12 GHz is described. The method includes connecting a metallic sheet on a bottom side of a dielectric substrate to an electrical ground. The method includes connecting a four patch antenna located on a top side of the dielectric substrate to an input signal source. The four patch antenna includes a circular ring path patch, a first feed branch patch, a feed port patch, and a second feed branch patch. The first feed branch patch is connected to the circular ring path patch. The first feed branch patch includes a straight leg which extends radially from the circular ring path patch and a curved leg having a first end connected to the straight leg. The leg is spaced from the circular ring path patch by a constant distance. The feed port patch has a first end of connected to a second end of the curved leg by a first microstrip wire line. The feed port patch extends radially away from the circular ring path patch. The second feed branch patch is connected to the circular ring path patch. The second feed branch patch includes a straight leg which extends radially from the circular ring path patch and a curved leg having a first end connected to the straight leg and a second leg connected to the first end of feed port patch by a second microstrip wireline. The curved leg is spaced from the circular ring path patch by a constant distance and wherein a length of the curved leg of the second feed branch is one half a length of the curved leg of the first feed branch. The connecting the four patch antenna to the input signal source includes connecting a second end of the feed port patch to the input signal source.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a top view of a fourth order orbital angular momentum (OAM) four patch antenna, according to certain embodiments.

FIG. 1B is a bottom view of the fourth order OAM four patch antenna, according to certain embodiments.

FIG. 2 is a graph of eigenvalues derived by the fourth order OAM four patch antenna for generating different modes, according to certain embodiments.

FIG. 3A represents a first degenerate mode (TM₅₁ mode) of the fourth order OAM four patch antenna, according to certain embodiments.

FIG. 3B represents a second degenerate mode (TM₅₁ mode) of the fourth order OAM four patch antenna with a 90° phase difference, according to certain embodiments.

FIG. 4 is a graph of a simulated reflection coefficient curve of s-parameters (S₁₁) of the fourth order OAM four patch antenna, according to certain embodiments.

FIG. 5 represents an electric field generated by the fourth order OAM four patch antenna, according to certain embodiments.

FIG. 6A is a three-dimensional (3-D) gain pattern of the fourth order OAM four patch antenna at phi=0°, according to certain embodiments.

FIG. 6B is a two-dimensional (2-D) gain pattern of the fourth order OAM four patch antenna at phi=90°, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about”, and similar terms generally refer to ranges that include the identified value within a margin of 20%, 10%, or preferably 5%, and any values therebetween.

Aspects of this disclosure are directed to a fourth order orbital angular momentum (OAM) patch antenna. The described antenna includes a circular ring path patch, which is fabricated on a dielectric substrate. The OAM patch antenna is small in size and has planar geometry with overall dielectric substrate dimensions of 150×150 mm². A modal analysis (modal analysis is a dynamic analysis that provides the natural frequencies at which a structure will resonate) of the circular ring path patch is carried out on a CST Studio to find the two degenerate modes from their corresponding eigenvalues. Then, the OAM patch antenna is fabricated on HFSS with similar dimensions. The described antenna is distinguished by its compact size, planar geometry, and simple feed structure. The OAM patch antenna operates in the C-band at a frequency of 5.12 GHz and is ideal for wireless applications.

In various aspects of the disclosure, definitions of one or more terms that will be used in the document are provided below.

The term “degenerate modes” is defined as two modes of propagation that share same cut-off frequency. It is known in the art that a rectangular waveguide does not support the TEM mode. The rectangular waveguide allows either the TE mode or the TM mode. The modes TEₘₙ and TMₘₙ are degenerate modes in the rectangular waveguide.

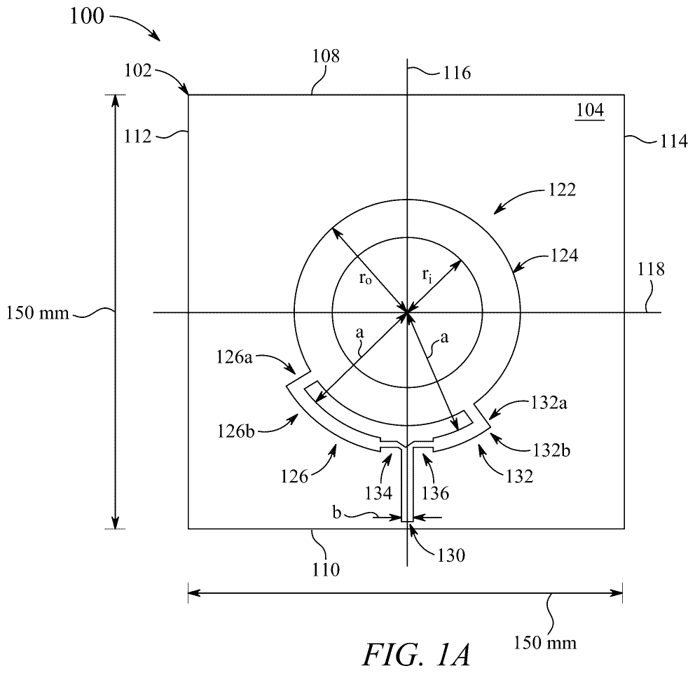

FIG. 1A-FIG. 1B illustrate an overall configuration of the fourth order OAM four patch antenna. In the drawings of FIG. 1A-FIG. 1B, dimensions shown are for the example of a 150×150 mm² dielectric substrate and should not be construed as limiting. For a dielectric substrate less than 150×150 mm², the dimensions are proportionately smaller. Similarly, for a dielectric substrate greater than 150×150 mm², the dimensions are proportionately larger.

FIG. 1A is a top view (front view or front side) of the fourth order OAM four patch antenna 100 (hereinafter interchangeably referred to as “the OAM patch antenna 100”). FIG. 1B illustrates a bottom view (back view or back side) of the OAM patch antenna 100.

As shown in FIG. 1A, the OAM patch antenna 100 includes a dielectric substrate 102, a metallic sheet 120, and a four patch antenna 122.

The dielectric substrate 102 has a surface dimension of about 150 mm in length and about 150 mm in width. The dielectric substrate 102 has a top side 104, a bottom side 106, a first edge 108, a second edge 110, a third edge 112, a fourth edge 114, a first central axis 116 and a second central axis 118. The first edge 108 is opposite to the second edge 110. The third edge 112 is opposite to the fourth edge 114. The first central axis 116 is configured to bisect the length of the dielectric substrate 102. The first central axis 116 extends from the first edge 108 to the second edge 110. The second central axis 118 is configured to bisect the width of the dielectric substrate 102. The second central axis 118 extends from the third edge 112 to the fourth edge 114. In an example, the dielectric substrate 102 is a Duroid substrate. In a non-limiting example, the Duroid substrate is RT-Duroid substrate (fabricated by Roger Cooperation, located at Chandler, 2225 W Chandler Blvd, United States). In a non-limiting example, the dielectric substrate 102 has a relative permittivity of 2.2 and a dielectric loss tangent of 0.0009.

The metallic sheet 120 is configured to cover the bottom side 106 of the dielectric substrate 102. The metallic sheet 120 is configured to connect to an electrical ground. The bottom side may be connected to the ground by any one of a wire, a cable, a connector, and the like. The dielectric substrate 102 and the metallic sheet 120 have the same dimensions, for example, 150 mm×150 mm. An edge of the metallic sheet 120 is connected to the electrical ground.

The four patch antenna 122 is located on the top side 104 of the dielectric substrate 102. The four patch antenna includes a circular ring path patch 124, a first feed branch patch 126, a feed port patch 130, and a second feed branch patch 132. The circular ring path patch 124 has a center located at an intersection of the first central axis 116 and the second central axis 118. For example, the circular ring path patch 124 has an inner radius (rᵢ) of about 21 mm. An outer radius (rₒ) of the circular ring path patch is about 39 mm.

The first feed branch patch 126 is connected to the circular ring path patch 124. The first feed branch patch 126 includes a straight leg 126a, and a curved leg 126b. The straight leg 126a extends radially from an outer perimeter of the circular ring path patch 124. In an example, the straight leg 126a of the first feed branch patch 126 is about 9.51 mm in length. The curved leg 126b has a first end and a second end. The first end of the curved leg 126b is connected to the straight leg 126a. The curved leg 126b is spaced from the circular ring path patch 124 by a constant distance. In an example, the curved leg 126b of the first feed branch patch 126 is about 34 mm in length.

The second feed branch patch 132 is connected to the circular ring path patch 124. The second feed branch patch 132 includes a straight leg 132a, and a curved leg 132b. The straight leg 132a extends radially from the circular ring path patch 124. The curved leg 132b has a first end and a second end. The first end of the curved leg 132b is connected to the straight leg 132a. The second end of the curved leg 132b is connected to the first end of the feed port patch 130. The curved leg 132b is spaced from the circular ring path patch 124 by a constant. In an example, the curved leg 126b of the first feed branch patch 126 and the curved leg 132b of the second feed branch patch 132 are spaced from the outer surface of the circular ring path patch 124 by about 9.51 mm. In an example, the straight leg of the second feed branch patch 132 is about 9.51 mm in length. In an example, the curved leg 132b of the second feed branch patch 132 is about 13 mm in length. In an aspect, a length of the curved leg 132b of the second feed branch patch 132 is one half a length of the curved leg of the first feed branch patch 126.

The feed port patch 130 extends from the circular ring path patch 124 towards the second edge 110 and is coincident with the first central axis 116. The feed port patch 130 has a first end and a second end. The first end of the feed port patch 130 is connected to the second end of the curved leg 126b of the first feed branch patch 126 by a first microstrip wire line 134. In an example, the first microstrip wire line 134 has a length of about 6.7 mm. In another aspect, the first end of the feed port patch 130 is connected to the second end of the curved leg 132b of the second feed branch patch 132 by a second microstrip wire line 136. In an example, the second microstrip wire line 136 has a length of about 6.7 mm. In an example, each of the straight legs 126a, 132a and the curved legs 126b, 132b of the first feed branch patch 126 and the second feed branch patch 132 has a width of about 4.5 mm and a width of the feed port patch 130 is about 4.5 mm.

The OAM patch antenna 100 is configured to resonate in a fourth order OAM mode at a frequency of 5.12 GHz when an electrical input signal is applied to the second end of the feed port patch 130. As the length of the curved leg 126b and the length of the curved leg 132b from the feed port patch 130 (central feed) is different, therefore both feed branch patches (the first feed branch patch 126, the second feed branch patch 132) are required to be fed with maximum current points as obtained from the modal analysis having 90 degree phase difference. In order to maintain the difference of 90 degree between both the feed branch patches (the first feed branch patch 126, the second feed branch patch 132), the feed port patch 130 (feed line) is divided into two branches using power divider rule in such a way that the difference in electrical lengths of both feed branch patches becomes λ/2 where λ is the effective length of the OAM patch antenna 100. The first feed branch patch 126 has a length of 3λ/4 and the second feed branch patch 132 has a length of λ/4. Due to 90 degree phase difference, the OAM patch antenna 100 is configured to yield two orthogonal degenerate modes of fourth order OAM. The degenerate modes is excited by the input signal are cancelled due to the length of the curved leg 132b of the second feed branch patch 132 being one half a length of the curved leg 126b of the first feed branch patch 126.

The effective length for the OAM patch antenna 100 is found using following procedure:

Determine the wavelength in free space λₒ, given by:

$${λ}_{o} = \frac{c}{f}$$

where c is the speed of light (3×10⁸ m/s) and f is the operating frequency of proposed antenna.

Calculate the effective wavelength λ_{eff} as follows:

$${λ}_{eff} = \frac{{λ}_{o}}{\sqrt{{ε}_{r}}}$$

where εᵣ is the relative permittivity of substrate used for the design of antenna.

Calculate the effective outer radius of the ring antenna as follows:

$${r}_{eff} = \frac{{X}_{n m} c}{2 π f \sqrt{{ε}_{r}}}$$

where Xₙₘ is m^{th} root of derivative of a Bessel function of order n whose value increases with increase in mode number.

In an aspect, a reconfigurable feed network (RFN) is used for the OAM patch antenna 100 having 0° and 90° phase shifting. The RFN is configured to generate radio-frequency signals with specific phase differences and inputs the radio-frequency signals into the feed branch patches (the first feed branch patch 126, the second feed branch patch 132). In an example, 4 phase shifting schemes are implemented to generate four modes by changing a sequence of a DC bias voltage.

During fabrication of the OAM patch antenna 100, the circular ring path patch 124, the first feed branch patch 126, the second feed branch patch 132, the feed port patch 130, the first microstrip wire line 134 and the second microstrip wire line 136 are formed onto the top side 104 of the dielectric substrate 102 by one of screen printing, flexography, rotogravure, offset printing and ink jet printing with epoxy type conductive ink loaded with conductive particles such as, for example, silver or gold or with a conductive polymer. Before forming the various components on the top side 104 of the dielectric substrate 102, the top side 104 of the dielectric substrate 102 may be covered with a metallic sheet which is lithographically etched away from the circular ring path patch 124, the first feed branch patch 126, the second feed branch patch 132, the feed port patch 130, the first microstrip wire line 134, and the second microstrip wire line 136.

In an aspect of the present disclosure, a mobile device is described, in which the mobile device includes the OAM patch antenna 104 shown in FIG. 1A and FIG. 1B. The OAM patch antenna 104 acts is part of a transceiver which receives and transmits OAM signals. The OAM patch antenna 104 may replace some or all of the plurality of directional antennas used in the mobile device which are needed for 5G communications.

In an aspect, the mobile device is a smart phone.

In an aspect, the mobile device is an access point.

The following experiments were conducted on the OAM patch antenna 100:

The following examples are provided to illustrate further and to facilitate the understanding of the present disclosure.

During experimentation, in a first step, the circular ring path patch 124 was analyzed using a CST STUDIO (CST Studio is a computational electromagnetics tool developed by Dassault Systèmes Simulia, Johnston, Rhode Island, USA). Using the CST STUDIO, a modal analysis of the circular ring path patch 124 was carried out. Modal analysis (eigenvalues analysis) is a dynamic analysis that provides the natural frequencies at which a radiating structure (antenna) will resonate. Eigenvalue analysis is used as a means of solving resonance problems that may cause mechanical damage to the circular ring path patch 124. In order to solve the resonance problem, it was required to first examine the vibration characteristics of the circular ring path patch 124. The eigenvalues analysis determines what vibrational mode (deformation state) occurs due to resonance of the circular ring path patch 124, having specific shape and material characteristics, with a specific natural frequency. In an example, the modal analysis was performed to determine eigenvalues and the corresponding two degenerate modes. The circular ring path patch 124 has “degenerate modes”, such that the orientation of the field generates different modes having the same cutoff frequency, impedance characteristics, and transverse electrical (TE) numbering designation. The degenerate modes are orthogonal. In the present disclosure for the transverse magnetic (TM) mode, that is, the TM₅₁ mode, there are two degenerate orthogonal modes.

The design parameters of the OAM patch antenna 100 were achieved by experimenting with varying size of the components. In an example, the OAM patch antenna 100 is configured to have various defined antenna parameters, and their values are listed in table 1.

TABLE 1
Defined parameters of the OAM patch antenna 100

| Variables | Values | |
|---|---|---|
| a | 48.51 | mm |
| b | 4.5 | mm |
| c | 18 | mm |
| rₒ | 39 | mm |
| rᵢ | 21 | mm |
| l_{g} | 150 | mm |
| w_{g} | 150 | mm |

The OAM patch antenna 100 of the present disclosure is distinguished by its compact size, planar geometry and simple feed structure. The OAM patch antenna 100 operates in the C-band at frequency of 5.12 GHz and is ideal for wireless applications.

After analyzing the shape and size of the circular ring path patch 124, the OAM patch antenna 100 was designed on HFSS (High Frequency Structure Simulator) with similar dimensions. Ansys HFSS is a 3D electromagnetic simulation software solution for designing and simulating high-frequency electronic products such as antennas, RF and microwave components, high-speed interconnects, filters, connectors, IC components and packages and printed circuit boards.

The fabricated OAM patch antenna 100 was developed, evaluated and analyzed using the Ansys Electronics Suite 2018. The Ansys Electromagnetics Suite (Ansys Electronics Desktop (AEDT) is developed by Ansys, Inc., Pennsylvania, USA). The Ansys Electronics Suite 2018 is a platform that enables electronic system design. The Ansys Electronics Suite 2018 is employed for work with antenna, RF, microwave, PCB, integrated circuit (IC) and IC package designs, along with electromechanical devices such as electric motors and generators.

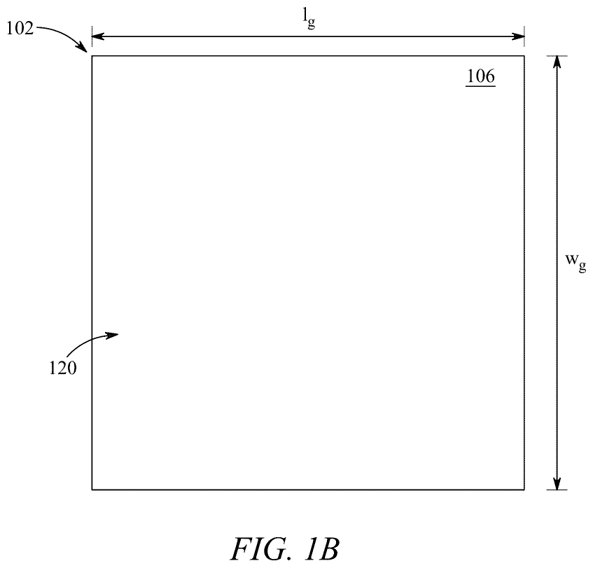

FIG. 2 is a graph 200 of eigenvalues derived by the OAM patch antenna 100 for generating different modes. To examine the operating mode of the OAM patch antenna 100, the modal analysis was performed using CST STUDIO. As the size of an antenna is directly proportional to the operating frequency and characteristic mode of the which antenna, the modes of the antenna must be determined. Therefore, a characteristic mode analysis was performed to determine eigenvalues. FIG. 2 shows the eigenvalues for the different modes that are supported by the four patch antenna. Curve 202 represents the eigenvalues for degenerate mode 1. Curve 204 represents the eigenvalues for degenerate mode 2. Curve 206 represents the eigenvalues for degenerate modes 3 and 4. Curve 208 represents the eigenvalues for degenerate mode 5. It can be observed that the curves for modes 3 and 4 are similar to each other, which can lead to the generation of additional degenerate modes.

Two degenerate higher-order modes of the antenna can be used to generate the OAM mode. The TMₘₙ mode can generate an OAM mode with a mode index of l, where |l|=m−1. In an example, the degenerate TM₂₁ modes can be used to generate the OAM modes with l=±1. Similarly, the degenerate TM₃₁ modes can be used to generate the OAM modes with l=±2. Different OAM modes generally have different resonance frequencies. Therefore, the OAM patch antenna 100 may also be used to generate different OAM modes at different frequencies. In designing the OAM patch antenna 100, it is essential to excite a proper TM mode that can be used to generate a twisted (OAM) wave, as each “twist” represents an information bit.

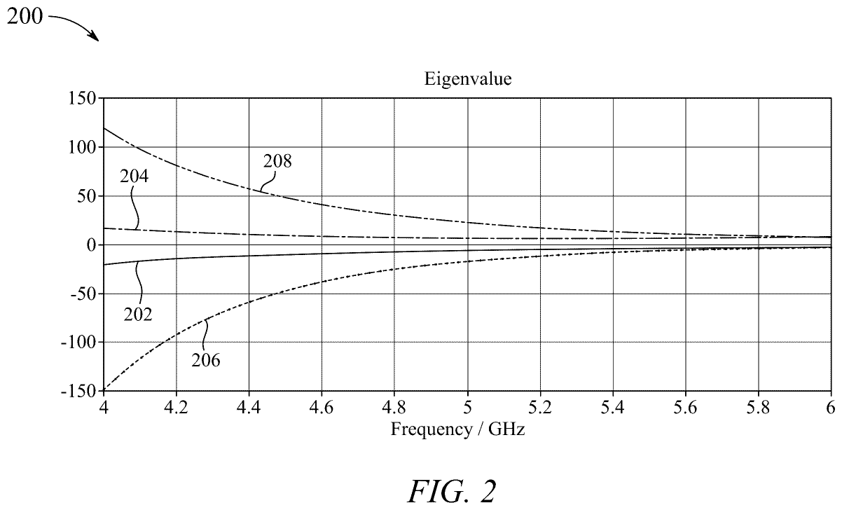

FIG. 3A-FIG. 3B represent the degenerate modes for corresponding curves of eigenvalues. The mode obtained from characteristic mode analysis is TM₅₁ which can produce the 4^{th} order OAM mode. FIG. 3A represents a first degenerate mode (TM₅₁ mode) 300 of the OAM patch antenna 100. FIG. 3B represents a second degenerate mode (TM₅₁ mode) 350 of the OAM patch antenna 100 with a 90° phase difference.

The arrows indicate the location of maximum currents obtained in alternate degenerate modes of FIG. 3A-FIG. 3B. The maximum current points are effective in locating the feeding points for the OAM patch antenna 100. In some examples, the maximum currents depend on length of the feeding lines, the structure of the circular ring path patch 124, structure of the OAM patch antenna 100, and surrounding environment. To excite the OAM patch antenna 100 using a dual feed approach (inputting signals using the first feed branch patch 126 and the second feed branch patch 132), two points of maximum current from alternate degenerate modes are chosen such that the difference between the lengths of both lines is equal to 90 degrees.

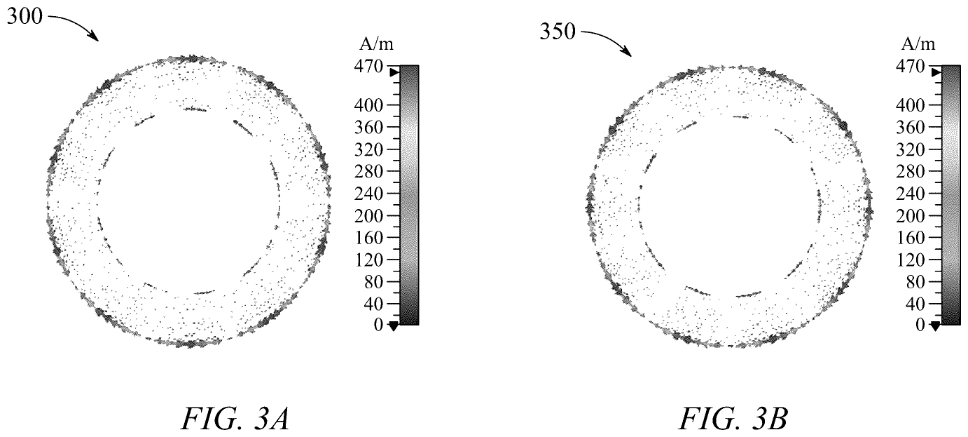

FIG. 4 is a graph 400 of a simulated reflection coefficient of scattering parameters (S-parameters) of the OAM patch antenna 100. The S-parameters (also called S-matrix) represent the linear characteristics of radio frequency (RF) electronic circuits and components. From the S-parameter matrix, various characteristics of a linear network such as gain, loss, impedance, phase group delay, and voltage standing wave ratio (VSWR) may be calculated. The S-parameters (S₁₁) describe the input-output relationship between ports (or terminals) in an electrical system. For example, if there are 2 ports (port 1 and port 2), then S₁₂ represents the power transferred from port 2 to port 1. S₂₁ represents the power transferred from port 1 to port 2. S₁₁ (return loss) represents how much power is reflected from the antenna, and hence is known as the reflection coefficient. If S₁₁=0 dB, then all the power is reflected from the antenna, and nothing is radiated. Signal 402 represents the simulated values of s-parameters (S₁₁).

It can be seen from FIG. 4 that the OAM patch antenna 100 exhibits return loss less than 10 dB at an operating frequency of 5.12 GHz which is effective for narrow band applications in wireless access networks. It is evident from the simulated S parameters that the OAM patch antenna 100 demonstrates good resonance characteristics which is an attractive feature for narrow band ring patch antennas.

### Experiment 1: Determining Near Field Characteristics of the OAM Patch Antenna 100

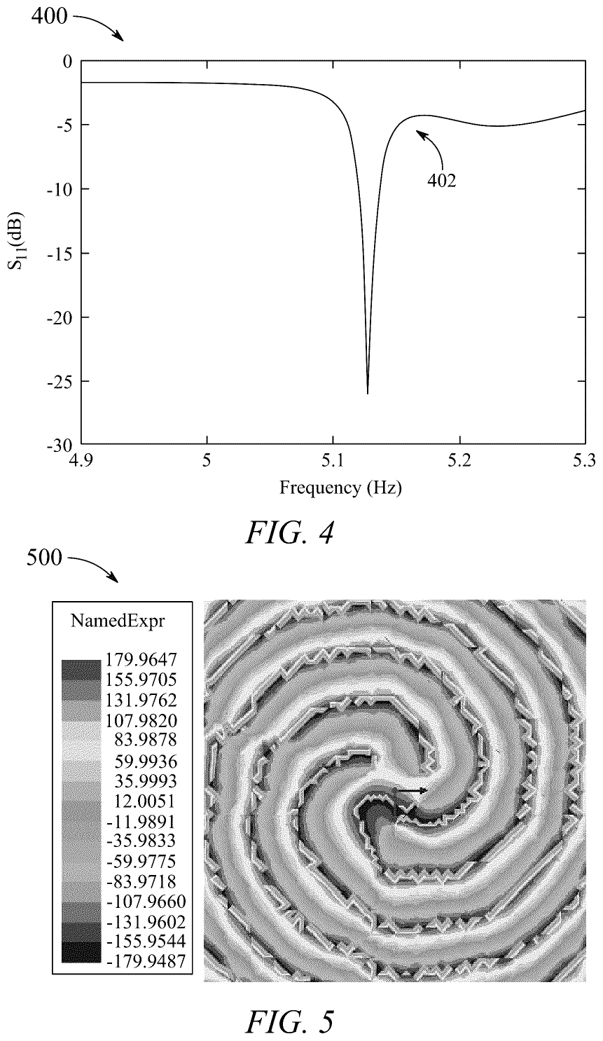

FIG. 5 represents a phase graph of the electric field 500 generated by the OAM patch antenna 100. From FIG. 5, it is obvious that the OAM patch antenna 100 is a fourth order OAM patch antenna with mode +4. Due to the fourth order OAM mode, the OAM patch antenna 100 has more capacity to transfer information in wireless communication as compared to a conventional simple patch antenna. Also, the 4^{th} mode has also been confirmed from the modal analysis of the OAM patch antenna 100. The phase of the OAM patch antenna 100 has been observed at a surface of 100 m from a patch plane with an area of 500 mm×500 mm. In order to observe the phase of the electric field 500 generated by the OAM patch antenna 100, the distance of the surface from the patch plane may be varied depending on the operating frequency and dimensions of the antenna. For example, the distance may increase for an array antenna due to its more directivity.

An antenna near field region is a region close to the antenna. It is also referred to as the reactive near field region. In this region, the electric and magnetic fields generated by the potential and current flow dominate. As mentioned, these fields are 90° out of phase with each other.

### Experiment 2: Determining Far Field Characteristics of the OAM Patch Antenna 100

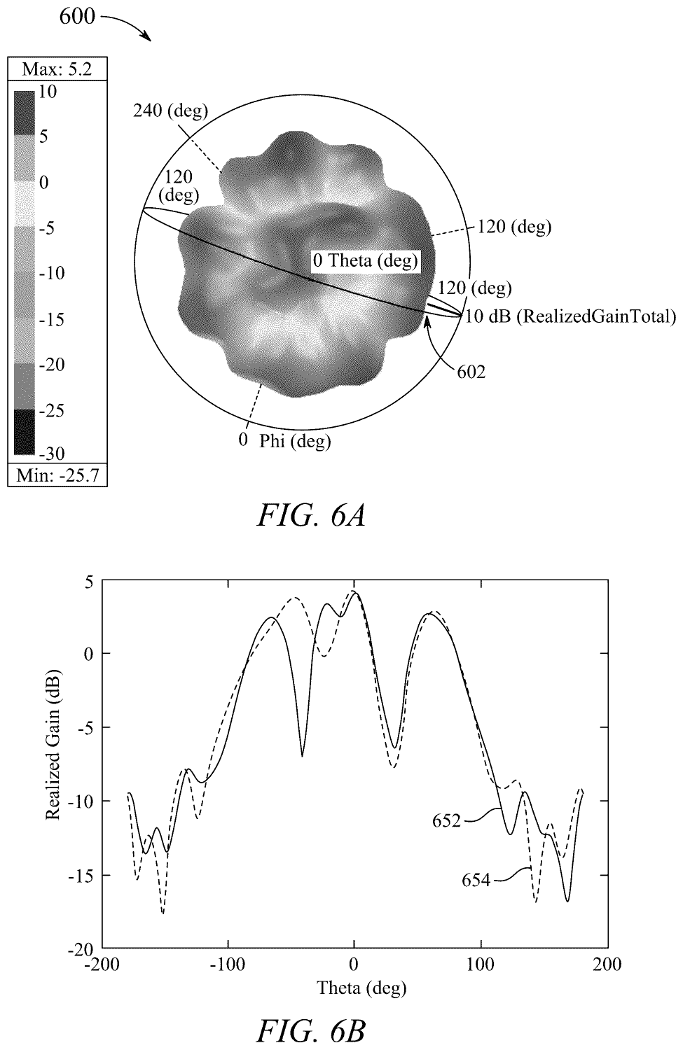

FIG. 6A-FIG. 6B represent the radiation pattern of the OAM patch antenna 100 in terms of the realized gain. FIG. 6A is a three-dimensional (3-D) gain pattern 600 of the OAM patch antenna 100 at phi=0°. Signal 602 represents the total realized gain of the OAM patch antenna 100. For an antenna, ϕ (phi) represents an angle between the x-axis and the projection of the point onto the x-y plane (ranges from 0 to 360 degrees).

FIG. 6B is a two-dimensional (2-D) gain pattern 650 of the OAM four patch antenna at phi=90°. Signal 652 represents the realized gain of the OAM four patch antenna at phi=0°. Signal 652 represents the realized gain of the OAM four patch antenna at phi=90°.

An antenna far field region is a region beyond a transition region where a local electric field and a local magnetic field have decayed to a point where they are negligible and can be ignored. The electromagnetic wave dominates in the far field region and is only detectable form of field.

As shown in FIG. 6A-FIG. 6B, the OAM patch antenna 100 demonstrates directional radiation as the four patch antenna 122 (ring patch) lies above the ground plane. It can be observed that the OAM patch antenna 100 exhibits a conical shape radiation pattern in which the size of the null in the broadside changes with the change of mode. The OAM patch antenna 100 has a realized gain of 5.2 dB, which is excellent for a single patch antenna operating at the 4^{th} order OAM mode and which reduces the extent of divergence during propagation.

The performance of the OAM patch antenna 100 of the present disclosure was compared with the conventional antenna designs and is summarized in Table 2. It is observed from the Table 2 that the OAM patch antenna 100 is efficient in comparison to conventional antenna designs. The OAM patch antenna 100 includes the excitation of higher OAM modes using the four patch antenna 122 with a simple feed structure. The OAM patch antenna 100 provides good characteristics in terms of substrate thickness, ground size, higher mode and feed excitation.

TABLE 2
Summary of performance comparison

| | Frequency | Substrate | Ground | Gain | Higher | Feed Excitation/ |
|---|---|---|---|---|---|---|
| Ref. | (GHz) | Thickness λₒ | Size λₒ² | (dB) | Mode | Cross Section |
| Li, W et al. | 5.035 | 0.016 | 4.05 | 6.89 | 3 | Edge |
| | | | | | | Feed/Medium |
| Shen et al. | 2.4 | 0.016 | 0.64 | 2.6 | 2 | Probe |
| | | | | | | Feed/Small |
| Ming et al. | 2.45 | 0.049 | 1.50 | 4.1 | 2 | Edge Feed/ |
| | | | | | | Large |
| Wang et al. | 5 | 0.033 | 5.44 | — | 1 | Edge |
| | | | | | | Feed/Medium |
| The present | 5.12 | 0.027 | 3.12 | 5.2 | 4 | Edge |
| OAM patch | | | | | | Feed/Small |
| antenna 100 | | | | | | |

The first embodiment is illustrated with respect to FIG. 1A-FIG. 1B. The first embodiment describes a fourth order orbital angular momentum (OAM) four patch antenna 100. The antenna 100 includes a dielectric substrate 102, a metallic sheet 120, and a four patch antenna 122. The dielectric substrate includes a top side 104 and a bottom side 106. The metallic sheet 120 is configured to cover the bottom side 106. The metallic sheet 120 is configured to connect to an electrical ground. The four patch antenna 122 is located on the top side 104. The four patch antenna includes a circular ring path patch 124, a first feed branch patch 126, and a second feed branch patch 132. The first feed branch patch 126 is connected to the circular ring path patch 124. The first feed branch patch 126 includes a straight leg which extends radially from the circular ring path patch 124 and a curved leg having a first end connected to the straight leg. The curved leg is spaced from the circular ring path patch 124 by a constant distance. A first end of a feed port patch 130 is operatively connected to a second end of the curved leg. The feed port patch 130 extends radially away from the circular ring path patch 124. The second feed branch patch 132 is connected to the circular ring path patch 124. The second feed branch patch 132 includes a straight leg which extends radially from the circular ring path patch 124 and a curved leg having a first end connected to the straight leg and a second leg operatively connected to the first end of feed port patch 130. The curved leg is spaced from the circular ring path patch 124 by a constant distance and wherein a length of the curved leg of the second feed branch is one half a length of the curved leg of the first feed branch. The fourth order OAM four patch antenna is configured to resonate in a fourth order OAM mode at a frequency of 5.12 GHz when an electrical input signal is applied to a second end of the feed port patch 130.

In an aspect, both the dielectric substrate and the metallic sheet have dimensions of 150 mm×150 mm.

In an aspect, the curved leg of the first feed branch patch 126 and the curved leg of the second feed branch patch 132 are spaced from an outer surface of the circular ring path patch 124 by about 9.51 mm.

In an aspect, degenerate modes excited by the input signal are cancelled due to the length of the curved leg of the second feed branch patch 132 being one half a length of the curved leg of the first feed branch patch 126.

In an aspect, the first end of the feed port patch 130 is connected to the second end of the curved leg of the first feed branch patch 126 by a first microstrip wire line 134 having a length of about 6.7 mm.

In an aspect, the first end of the feed port patch 130 is connected to the second end of the curved leg of the second feed branch patch 132 by a second microstrip wire line 136 having a length of about 6.7 mm.

In an aspect, the curved leg of the first feed branch patch 126 is about 34 mm in length and the curved length of the second feed branch is about 13 mm in length.

In an aspect, the straight leg of the first feed branch patch 126 and the straight leg of the second feed branch patch 132 are each about 8.51 mm in length.

In an aspect, the dielectric substrate has a relative permittivity of 2.2 and dielectric loss tangent of 0.0009.

In an aspect, an inner radius of the circular ring path patch 124 is about 21 mm, an outer radius of the circular ring path patch 124 is about 39 mm and a width of each of the straight leg and the curved leg of the first feed branch patch 126, a width of the straight leg and the curved leg of the second feed branch patch 132, and a width of the feed port patch 130 are each about 4.5 mm.

The second embodiment is illustrated with respect to FIG. 1A-FIG. 1B. The second embodiment describes a method of making a fourth order orbital angular momentum (OAM) four patch antenna. The method includes selecting a dielectric substrate including a top side 104 and a bottom side 106, a first edge 108, a length of about 150 mm and a width of about 150 mm, a top side 104, a bottom side 106, a first edge 108 opposite a second edge 110, and a third edge 112 opposite a fourth edge 114, a first central axis 116 bisecting the length and extending from the first edge 108 to the second edge 110, a second central axis 118 bisecting the width and extending from the third edge 112 to the fourth edge 114. The method includes covering the bottom side 106 with a metallic sheet 120. The method includes connecting an edge of the metallic sheet to an electrical ground. The method includes forming a four patch antenna on the top side 104. Forming the four patch antenna includes forming a circular ring path patch 124 having a center located at an intersection of the first central axis 116 and the second central axis 118, forming a first feed branch patch 126 connected to the circular ring path patch 124, wherein the first feed branch patch 126 includes a straight leg which extends radially outward from an outer perimeter of the circular ring path patch 124, and a curved leg having a first end connected to the straight leg, wherein the curved leg is spaced from the circular ring path patch 124 by a constant distance, forming a feed port patch 130 having a first end operatively connected to a second end of the curved leg of the first feed branch patch 126, wherein the feed port patch 130 extends from the circular ring path patch 124 towards the second edge 110 and is coincident with the first central axis, and forming a second feed branch patch 132 connected to the circular ring path patch 124, wherein the second feed branch patch 132 includes a straight leg which extends radially outward from the circular ring path patch 124 and a curved leg having a first end connected to the straight leg of the second feed branch patch 132 and a second end operatively connected to the first end of the feed port patch 130, wherein the curved leg is spaced from the circular ring path patch 124 by a constant distance and wherein a length of the curved leg of the second feed branch is one half a length of the curved leg of the first feed branch. The method includes connecting an electrical input signal to a second end of the feed port patch 130, wherein the electrical input signal is configured to cause the fourth order OAM four patch antenna to resonate in a fourth order OAM mode at a frequency of 5.12 GHz.

In an aspect, the method includes spacing the curved leg of the first feed branch patch 126 and the curved leg of the second feed branch patch 132 from an outer surface of the circular ring path patch 124 by about 9.51 mm.

In an aspect, the method includes forming the curved leg of the first feed branch patch 126 to have a length of about 34 mm, and forming the curved leg of the second feed branch to have a length of about 13 mm.

In an aspect, the method includes forming the straight leg of the first feed branch patch 126 and the straight leg of the second feed branch patch 132 to each have a length of about 8.51 mm.

In an aspect, the method includes selecting the dielectric substrate to have a relative permittivity of 2.2 and dielectric loss tangent of 0.0009.

In an aspect, the method includes connecting the first end of the feed port patch 130 to the second end of the curved leg of the first feed branch patch 126 by a first microstrip wire line 134 having a length of about 6.7 mm.

In an aspect, the method includes connecting the first end of the feed port patch 130 to the second end of the curved leg of the second feed branch patch 132 by a second microstrip wire line 136 having a length of about 6.7 mm.

In an aspect, the forming the fourth order OAM patch antenna comprises ink jet printing the circular ring path patch 124, the first feed branch patch 126, the second feed branch patch 132, the feed port patch 130, the first microstrip wire line 134 and the second microstrip wire line 136 onto the top side 104 of the dielectric substrate.

In an aspect, the forming the fourth order OAM patch antenna includes covering the top side 104 of the dielectric substrate with a metallic sheet, and lithographically etching away the metallic sheet from the circular ring path patch 124, the first feed branch patch 126, the second feed branch patch 132, the feed port patch 130, the first microstrip wire line 134 and the second microstrip wire line 136.

The third embodiment is illustrated with respect to FIG. 1A-FIG. 1B. The third embodiment describes a method for transmitting fourth order orbital angular momentum (OAM) signals at a frequency of 5.12 GHz. The method includes connecting a metallic sheet on a bottom side 106 of a dielectric substrate to an electrical ground. The method includes connecting a four patch antenna located on a top side 104 of the dielectric substrate to an input signal source. The four patch antenna includes a circular ring path patch 124, a first feed branch patch 126, a feed port patch 130, and a second feed branch patch 132. The first feed branch patch 126 is connected to the circular ring path patch 124. The first feed branch patch 126 includes a straight leg which extends radially from the circular ring path patch 124 and a curved leg having a first end connected to the straight leg. The leg is spaced from the circular ring path patch 124 by a constant distance. The feed port patch 130 has a first end of connected to a second end of the curved leg by a first microstrip wire line. The feed port patch 130 extends radially away from the circular ring path patch 124. The second feed branch patch 132 is connected to the circular ring path patch 124. The second feed branch patch 132 includes a straight leg which extends radially from the circular ring path patch 124 and a curved leg having a first end connected to the straight leg and a second leg connected to the first end of feed port patch 130 by a second microstrip wireline. The curved leg is spaced from the circular ring path patch 124 by a constant distance and wherein a length of the curved leg of the second feed branch is one half a length of the curved leg of the first feed branch. The connecting the four patch antenna to the input signal source includes connecting a second end of the feed port patch 130 to the input signal source.

Numerous modifications and variations of the present disclosure are possible in light of the above teachings. It is therefore to be understood that within the scope of the appended claims, the invention may be practiced otherwise than as specifically described herein.

1. A fourth order orbital angular momentum (OAM) four patch antenna, comprising:
a dielectric substrate including a top side and a bottom side;
a metallic sheet configured to cover the bottom side, wherein the metallic sheet is configured to connect to an electrical ground;
a four patch antenna located on the top side, wherein the four patch antenna includes:
a circular ring path patch;
a first feed branch patch connected to the circular ring path patch, wherein the first feed branch patch includes a straight leg which extends radially from the circular ring path patch and a curved leg having a first end connected to the straight leg, wherein the curved leg is spaced from the circular ring path patch by a constant distance;
a first end of a feed port patch is operatively connected to a second end of the curved leg, wherein the feed port patch extends radially away from the circular ring path patch; and
a second feed branch patch connected to the circular ring path patch, wherein the second feed branch patch includes a straight leg which extends radially from the circular ring path patch and a curved leg having a first end connected to the straight leg and a second leg operatively connected to the first end of feed port patch, wherein the curved leg is spaced from the circular ring path patch by a constant distance and wherein a length of the curved leg of the second feed branch is one half a length of the curved leg of the first feed branch patch,
wherein the fourth order OAM four patch antenna is configured to resonate in a fourth order OAM mode at a frequency of 5.12 GHz when an electrical input signal is applied to a second end of the feed port patch.

2. The fourth order OAM patch antenna of claim 1, wherein both the dielectric substrate and the metallic sheet have dimensions of 150 mm×150 mm.

3. The fourth order OAM patch antenna of claim 1, wherein the curved leg of the first feed branch patch and the curved leg of the second feed branch patch are spaced from an outer surface of the circular ring path patch by about 9.51 mm.

4. The fourth order OAM patch antenna of claim 1, wherein degenerate modes excited by the input signal are cancelled due to the length of the curved leg of the second feed branch patch being one half a length of the curved leg of the first feed branch patch.

5. The fourth order OAM patch antenna of claim 1, wherein the first end of the feed port patch is operatively connected to the second end of the curved leg of the first feed branch patch by a first microstrip wire line having a length of about 6.7 mm.

6. The fourth order OAM patch antenna of claim 5, wherein the first end of the feed port patch is operatively connected to the second end of the curved leg of the second feed branch patch by a second microstrip wire line having a length of about 6.7 mm.

7. The fourth order OAM patch antenna of claim 1, wherein the curved leg of the first feed branch patch is about 34 mm in length and the curved length of the second feed branch patch is about 13 mm in length.

8. The fourth order OAM patch antenna of claim 1, wherein the straight leg of the first feed branch patch and the straight leg of the second feed branch patch are each about 8.51 mm in length.

9. The fourth order OAM patch antenna of claim 1, wherein the dielectric substrate has a relative permittivity of 2.2 and dielectric loss tangent of 0.0009.

10. The fourth order OAM patch antenna of claim 1, wherein an inner radius of the circular ring path patch is about 21 mm, an outer radius of the circular ring path patch is about 39 mm and a width of each of the straight leg and the curved leg of the first feed branch patch, a width of the straight leg and the curved leg of the second feed branch patch, and a width of the feed port patch are each about 4.5 mm.

11. A method of making a fourth order orbital angular momentum (OAM) four patch antenna, comprising:
selecting a dielectric substrate including a top side and a bottom side, a first edge, a length of about 150 mm and a width of about 150 mm, a top side, a bottom side, a first edge opposite a second edge, and a third edge opposite a fourth edge, a first central axis bisecting the length and extending from the first edge to the second edge, a second central axis bisecting the width and extending from the third edge to the fourth edge;
covering the bottom side with a metallic sheet;
connecting an edge of the metallic sheet to an electrical ground;
forming a four patch antenna on the top side, wherein forming the four patch antenna includes:
forming a circular ring path patch having a center located at an intersection of the first central axis and the second central axis;
forming a first feed branch patch connected to the circular ring path patch, wherein the first feed branch patch includes a straight leg which extends radially outward from an outer perimeter of the circular ring path patch, and a curved leg having a first end connected to the straight leg, wherein the curved leg is spaced from the circular ring path patch by a constant distance;
forming a feed port patch having a first end operatively connected to a second end of the curved leg of the first feed branch patch, wherein the feed port patch extends from the circular ring path patch towards the second edge and is coincident with the first central axis; and
forming a second feed branch patch connected to the circular ring path patch, wherein the second feed branch patch includes a straight leg which extends radially outward from the circular ring path patch and a curved leg having a first end connected to the straight leg of the second feed branch patch and a second end operatively connected to the first end of the feed port patch, wherein the curved leg is spaced from the circular ring path patch by a constant distance and wherein a length of the curved leg of the second feed branch is one half a length of the curved leg of the first feed branch; and
connecting an electrical input signal to a second end of the feed port patch, wherein the electrical input signal is configured to cause the fourth order OAM four patch antenna to resonate in a fourth order OAM mode at a frequency of 5.12 GHz.

12. The method of claim 11, further comprising:
spacing the curved leg of the first feed branch patch and the curved leg of the second feed branch patch from an outer surface of the circular ring path patch by about 9.51 mm.

13. The method of claim 11, further comprising:
forming the curved leg of the first feed branch patch to have a length of about 34 mm; and
forming the curved leg of the second feed branch to have a length of about 13 mm.

14. The method of claim 11, further comprising:
forming the straight leg of the first feed branch patch and the straight leg of the second feed branch patch to each have a length of about 8.51 mm.

15. The method of claim 11, further comprising:
selecting the dielectric substrate to have a relative permittivity of 2.2 and dielectric loss tangent of 0.0009.

16. The method of claim 11, further comprising:
connecting the first end of the feed port patch to the second end of the curved leg of the first feed branch patch by a first microstrip wire line having a length of about 6.7 mm.

17. The method of claim 16, further comprising:
connecting the first end of the feed port patch to the second end of the curved leg of the second feed branch patch by a second microstrip wire line having a length of about 6.7 mm.

18. The method of claim 17, wherein forming the fourth order OAM patch antenna comprises ink jet printing the circular ring path patch, the first feed branch patch, the second feed branch patch, the feed port patch, the first microstrip wire line and the second microstrip wire line onto the top side of the dielectric substrate.

19. The method of claim 17, wherein forming the fourth order OAM patch antenna comprises:
covering the top side of the dielectric substrate with a metallic sheet; and
lithographically etching away the metallic sheet from the circular ring path patch, the first feed branch patch, the second feed branch patch, the feed port patch, the first microstrip wire line and the second microstrip wire line.

20. A method for transmitting fourth order orbital angular momentum (OAM) signals at a frequency of 5.12 GHz, comprising:
connecting a metallic sheet on a bottom side of a dielectric substrate to an electrical ground;
connecting a four patch antenna located on a top side of the dielectric substrate to an input signal source;
wherein the four patch antenna includes:
a circular ring path patch;
a first feed branch patch connected to the circular ring patch, wherein the first feed branch patch includes a straight leg which extends radially from the circular ring path patch and a curved leg having a first end connected to the straight leg, wherein the curved leg is spaced from the circular ring path patch by a constant distance;
a feed port patch having a first end connected to a second end of the second leg by a first microstrip wire line, wherein the feed port patch extends radially away from the circular ring path patch; and
a second feed branch patch connected to the circular ring path patch, wherein the second feed branch patch includes a straight leg which extends radially from the circular ring patch and a curved leg having a first end connected to the straight leg and a second leg connected to the first end of feed port patch by a second microstrip wireline, wherein the curved leg is spaced from the circular ring path patch by a constant distance and wherein a length of the curved leg of the second feed branch is one half a length of the curved leg of the first feed branch; and
wherein connecting the four patch antenna to the input signal source comprises connecting a second end of the feed port patch to the input signal source.
